(19) United States
(12) Patent Application Publication
(10) Pub. No.: US 2024/0320688 A1
(43) Pub. Date: Sep. 26, 2024

(54) ESTIMATING SYSTEM AND ESTIMATING METHOD FOR ENERGY-SAVING AND EMISSION-REDUCTION OF ENERGY-CONSUMPTION DEVICE

(71) Applicant: CHICONY POWER TECHNOLOGY CO., LTD., NEW TAIPEI CITY (TW)

(72) Inventors: Tse-Wen CHANG, NEW TAIPEI CITY (TW); Te-Mei TU, NEW TAIPEI CITY (TW); Jewel TSAI, NEW TAIPEI CITY (TW)

(21) Appl. No.: 18/372,157

(22) Filed: Sep. 25, 2023

(30) Foreign Application Priority Data
Mar. 23, 2023 (TW) 112110870

(51) Int. Cl. G06Q 30/018

(52) U.S. Cl. CPC G06Q 30/018

(57) ABSTRACT

An estimating system for energy-saving and emission-reduction is provided and includes an energy-consumption device operating in the environment based on multiple operating parameters to generate an energy-consumption and carbon-emission result and a server for receiving and storing corresponding values of each operating parameter of the energy-consumption device. The server includes an energy-consumption factor analyzing module for selecting multiple energy-consumption factors relevant to power-consumed amount and carbon-emitted amount from the multiple operating parameters, a new-device-parameter importing module for importing multiple performance coefficients of multiple new devices, and a simulating module for performing a simulation and calculating an energy-consumption simulated result of each new device as if each new device were operated under same environment within a specific historical time-period. The server performs a replacement-benefit estimating procedure for each new device based on the energy-consumption and carbon-emission result of the energy-consumption device and the energy-consumption simulated results of each new device.

### BACKGROUND OF THE INVENTION

### 1. Technical Field

The present disclosure relates to an estimating system and an estimating method, and specifically to an estimating system and an estimating method for estimating the benefit of energy-saving and emission-reduction.

### 2. Description of Related Art

The current building monitoring systems collect and analyze data relevant to energy-consumption and carbon-emission, such as electricity, water, or gas consumed by each energy-consumption/carbon-emission device of a building. Besides, these building monitoring systems store the analyzed result into a database, so that users may search for the required data from the database in accordance with time-period.

However, these building monitoring systems may only analyze the energy-consumption and carbon-emission of each current-existing device, but are incapable of estimating an improving benefit for these devices in order for energy-saving and emission-reduction.

In the environment with an ultimate goal of zero emissions, the users need to know about the current situation of the energy-consumption/carbon-emission devices currently existed in the building, so that the users may perform improvement approaches or purchase new devices to replace certain devices that currently exist and consume more power or emit more carbon. Therefore, the entire power-consumed amount and carbon-emitted amount can be reduced. However, if the building monitoring systems cannot estimate the difference between the power-consumed amount and carbon-emitted amount of the current existing device and that of a new device being evaluated, the users can barely implement the ultimate goal of zero emissions.

### SUMMARY OF THE INVENTION

The present disclosure is directed to an estimating system and an estimating method for energy-saving and emission-reduction of an energy-consumption device, which may estimate the benefit of energy-saving and emission-reduction after replacing current existing energy-consumption devices with new devices.

In one of the exemplary embodiments, the estimating system for energy-saving and emission-reduction of energy-consumption device of the present disclosure includes: an energy-consumption device being arranged in an environment, configured to continuously operate in accordance with multiple operating parameters and generate an energy-consumption and carbon-emission result:
an IO module connected with the energy-consumption device, configured to obtain corresponding values of each of the operating parameters while the energy-consumption device operates;
a server connected with the IO module through a network communication device, configured to receive each of the operating parameters of the energy-consumption device and the corresponding values of each of the operating parameters, and including: an operating-parameter storing module, configured to store the corresponding values of each of the operating parameters based on a time series;
an energy-consumption factor analyzing module, configured to select a part of the operating parameters that are relevant to the energy-consumption and carbon-emission result within a specific historical time-period from the multiple operating parameters based on the corresponding values to be multiple energy-consumption factors;
a new-device-parameter importing module, configured to import multiple performance coefficients of multiple new devices, wherein the multiple new devices and the energy-consumption device are devices with same type; and
a simulating module, configured to respectively perform a simulation and calculate an energy-consumption simulated result of each of the new devices as if each of the new devices were operated in the environment within the specific historical time-period based on the multiple performance coefficients of each of the new devices and the multiple energy-consumption factors;
wherein, the server is configured to perform a replacement-benefit estimating procedure based on the energy-consumption and carbon-emission result of the energy-consumption device within the specific historical time-period and each energy-consumption simulated result of each new device.

In one of the exemplary embodiments, the estimating method for energy-saving and emission-reduction of energy-consumption device of the present disclosure is incorporated with the estimating system mentioned and includes following steps of:
a) selecting the energy-consumption device;
b) importing the multiple operating parameters of the energy-consumption device;
c) selecting a part of the operating parameters that are relevant to the energy-consumption and carbon-emission result within a specific historical time-period from the multiple operating parameters to be multiple energy-consumption factors;
d) obtaining multiple performance coefficients of multiple new devices, wherein the multiple new devices and the energy-consumption device are devices of same type;
e) respectively performing a simulation and calculating an energy-consumption simulated result of each of the new devices as if each of the new devices were operated in the environment within the specific historical time-period in accordance with the multiple performance coefficients of each of the new devices and the multiple energy-consumption factors; and
f) performing a replacement-benefit estimating procedure for each of the new devices based on the energy-consumption and carbon-emission result of the energy-consumption device within the specific historical time-period and each energy-consumption simulated result of each of the new devices.

In comparison with related art, the present disclosure predicts the power-consumption and carbon-emission situation if new devices were in operation based on the records of the current existing energy-consumption devices ran in the environment, so as to estimate the benefit of energy-saving and emission-reduction and investment returns. In sum, the present disclosure is capable of assisting the users to precisely and rapidly schedule the improving approach to the environment care, so as to accelerate the target schedule for the purpose of energy-saving and emission-reduction.

### BRIEF DESCRIPTION OF THE DRAWINGS

FIG. 1 is a block diagram of an estimating system of an embodiment according to the present disclosure.

FIG. 2 is a schematic diagram of a server of an embodiment according to the present disclosure.

FIG. 3 is a flowchart of an estimating method of an embodiment according to the present disclosure.

FIG. 4 is a flowchart of selecting energy-consumption factor of an embodiment according to the present disclosure.

FIG. 5 is a flowchart of comparing investment returns of an embodiment according to the present disclosure.

### DETAILED DESCRIPTION OF THE INVENTION

In cooperation with the attached drawings, the technical contents and detailed description of the present invention are described thereinafter according to multiple embodiments, being not used to limit its executing scope. Any equivalent variation and modification made according to appended claims is all covered by the claims claimed by the present invention.

To save energy and reduce carbon-emission for a certain environment (such as a building), it has to be known that which energy-consumption devices exist in the environment and which factors of the energy-consumption devices affect the power-consumed amount/carbon-emitted amount of the energy-consumption devices, such as air-conditioners, air compressors, and lighting equipment, etc. If the factors affecting the power-consumed amount/carbon-emitted amount are known, the user may use the factors to predict a power-consumed predicting amount and a carbon-emitted predicting amount that probably occur after new devices are applied before purchasing these new devices. Therefore, the user may use the system to estimate the benefit of energy-saving and emission-reduction, so as to decide which improving approaches should be adopted or which new devices should be purchased and replaced (evaluated).

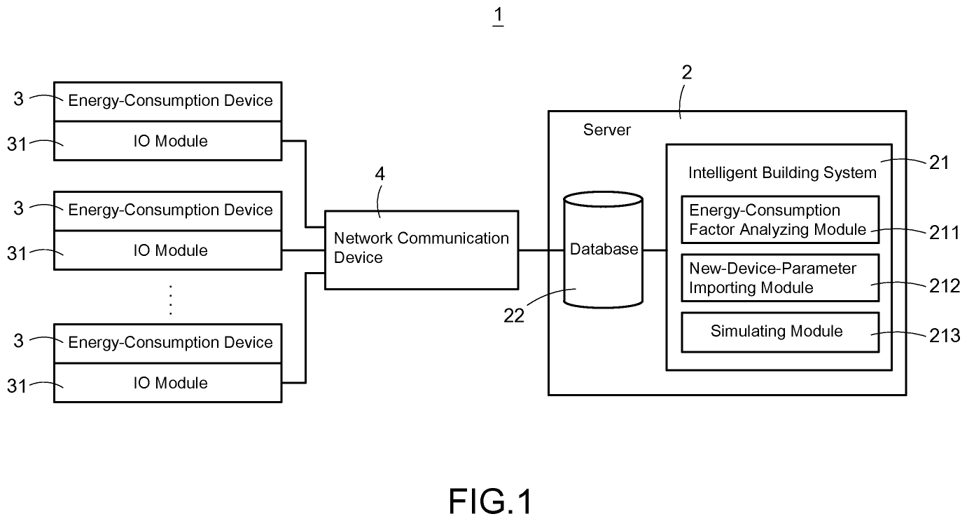

Please refer to FIG. 1, which is a block diagram of an estimating system of an embodiment according to the present disclosure. The present disclosure discloses an estimating system for energy-saving and emission-reduction of energy-consumption devices (referred to as the estimating system 1 hereinafter). As shown in FIG. 1, the estimating system 1 includes a server 2 and one or more energy-consumption devices 3, wherein each of the energy-consumption devices 3 respectively has an IO module 31 correspondingly. The server 2 connects to a network communication device 4 through Internet Protocol and connects to each IO module 31 of each energy-consumption device 3 via the network communication device 4.

The energy-consumption devices 3 in the present disclosure may be electronic devices arranged in a specific environment (such as a building), e.g., air-conditioners, air-compressors, or lighting equipment, etc., but not limited to. The energy-consumption devices 3 consume power and emit carbon while operating. For the sake of understanding, these kinds of electronic devices are regarded as the energy-consumption devices. In the following description, one energy-consumption device 3 is taken as an example to interpret the embodiments in a non-limiting way.

The energy-consumption device 3 has a plurality of operating parameters based on its operating functions. Taking the air-conditioner as an example, the plurality of operating parameters may be water temperature, flowing amount, and cooling ability, etc., but not limited thereto. The operating parameters here are variables relative to the ability of the energy-consumption device 3 where each of the operating parameters generates a corresponding value along with the operation of the energy-consumption device 3. For example, a first operating parameter of the energy-consumption device 3 is water temperature and the corresponding value of the first operating parameter is 5° C. or 10° C. For another example, a second operating parameter of the energy-consumption device 3 is flowing amount and the corresponding value of the second operating parameter is 100CMH or 150CMH, etc.

After the energy-consumption device 3 is arranged to the specific environment and activated, it may continuously operate in accordance with the plurality of operating parameters. Along with the operation of the energy-consumption device 3, an energy-consumption and carbon-emission result is generated correspondingly, where the energy-consumption and carbon-emission result is used to represent a power-consumed amount and carbon-emitted amount generated by the energy-consumption device 3 as time passes.

The IO module 31 connects to the energy-consumption device 3 to obtain the corresponding value of each operating parameter while the energy-consumption device 3 operates. In one embodiment, the IO module 31 is a wireless transmitting interface, and the energy-consumption device 3 wirelessly connects with the network communication device 4 through the IO module 31. In another embodiment, the IO module 31 is a wired transmitting interface, and the energy-consumption device 3 connects with the network communication device 4 through the IO module 31 with cable(s).

As mentioned above, each of the operating parameters may respectively generate different values while the energy-consumption device 3 operates. In the present disclosure, the corresponding value of each operating parameter obtained by the IO module 31 includes a time stamp. The estimating system 1 records the corresponding values of each of the plurality of operating parameters of the energy-consumption device 3 at different time points to be historical data.

The server 2 connects to the network communication device 4 through network and connects to the energy-consumption device 3 through the network communication device 4. In the present disclosure, the server 2 continuously receives each operating parameter of the energy-consumption device 3 and the corresponding values of each of the operating parameters of the energy-consumption device 3 through the network communication device 4 and the IO module 31.

In the embodiment of FIG. 1, the server 2 is divided into an intelligent building system 21 and a database 22 due to the functions being implemented. In one embodiment, the server 2 records each operating parameter of the energy-consumption device 3 and the corresponding values of each of the operating parameters into the database 22. In particular, the database 22 stores the corresponding values of each of the operating parameters of the energy-consumption device 3 based on a time series, so that the intelligent building system 21 may use the data stored in the database 22 to estimate the benefit of energy-saving and emission-reduction.

The intelligent building system 21 includes an energy-consumption factor analyzing module 211, a new-device-parameter importing module 212, and a simulating module 213. In one embodiment, the above modules 211-213 are hardware modules implemented by physical components, such as micro control units (MCUs), central process units (CPUs), system on chip (SoC), or programmable logic controllers (PLCs). In another embodiment, the server 2 has computer-executable program codes. When the server 2 executes the computer-executable program codes, the above modules 211-213 may be created and ran in accordance with functions required by the server 2. In other words, the above modules 211-213 may be software modules, but not limited thereto. Also, the modules 211-213 may be implemented by a combination of hardware module(s) and software module(s).

The energy-consumption factor analyzing module 211 analyzes the plurality of operating parameters of the energy-consumption device 3, so as to select one or more energy-consumption factors that are highly relevant to the power-consumed amount or carbon-emitted amount of the energy-consumption device 3 operating in the current environment (such as the energy-consumption and carbon-emission result of the energy-consumption device 3).

In particular, in order to analyze the energy-consumption factors, the user may input a specific historical time-period being analyzed through a human-machine interface (not shown in the FIGs) of the intelligent building system 1. The specific historical time-period includes date and time. For example, the specific historical time-period may be October 1 to October 30, AM.9:00 to PM.5:00 from Monday to Friday. In one embodiment, the specific historical time-period should be the time period that the energy-consumption device 3 being analyzed did operate before in the environment.

After the user sets the specific historical time-period, the energy-consumption factor analyzing module 211 reads the corresponding values of each of the operating parameters of the energy-consumption device 3 within the specific historical time-period from the database 22. Therefore, the energy-consumption factor analyzing module 211 may select a part of the operating parameters that are relevant to the power-consumed amount and carbon-emitted amount of the energy-consumption device 3 operating in the environment within the specific historical time-period from the plurality of operating parameters in accordance with the corresponding values. It is understood that not every operating parameter of the energy-consumption device 3 is highly relevant to the power-consumed amount and carbon-emitted amount, so that the energy-consumption factor analyzing module 211 has to perform a selecting action as mentioned above to select a part of the operating parameters that are relevant to the power-consumed amount and carbon-emitted amount of the energy-consumption device 3 operating in the environment within the specific historical time-period.

In one embodiment, after the above selecting action, the energy-consumption factor analyzing module 211 regards the part of operating parameters being selected as the energy-consumption factors that are used to estimate the benefit of energy-saving and emission-reduction. In another embodiment, the energy-consumption factor analyzing module 211 performs a second selecting action or even a third selecting action to the part of operating parameters being selected to further ensure that the energy-consumption factors being retained are highly relevant to the power-consumed amount and carbon-emitted amount.

In the relate art, when the user changes a new device to the environment, the user can only predict the power-consumed amount and carbon-emitted amount of the new device with assumptions. For example, it is known that the current existing energy-consumption device 3 has an average power-consumed amount of X kW, and the new device has an average power-consumed amount of Y kW, then if the device will be used for Z hours in a day, it can be predicted that how many power-consumed amount can be saved after the current existing energy-consumption device is replaced with the new device. However, the predicted result is not relating to the actual operating status of the new device being arranged. Besides, the power-consumed amount of a part of devices is not always the same and may be affected by external environmental conditions, such as the human traffic in the environment, the outdoor temperature, or the outdoor humidity, etc. That is, it will be inaccurate if the total power-consumed amount and carbon-emitted amount within a future period is predicted only based on a fixed power-consumed amount.

According to the above problem, the present disclosure uses the operating condition of the current existing energy-consumption device 3 in the environment (i.e., the actual operating time, locations, and conditions of the energy-consumption device 3), finds a plurality of operating parameters that are highly relevant to the power-consumed amount and carbon-emitted amount of these kinds of devices currently operating in the current environment, and then uses the same operating parameters of the new device to predict the actual power-consumed amount and carbon-emitted amount of the new device after being arranged in the current environment. Therefore, the intelligent building system 21 of the present disclosure may precisely estimate the benefit of the new device for energy-saving and emission-reduction.

The new-device-parameter importing module 212 accepts user's operation through the human-machine interface of the intelligent building system 21 to import the plurality of performance coefficients of multiple new devices. In particular, the object of the present disclosure is to estimate the benefit of replacing the current existing energy-consumption device 3 with the new device for energy-saving and emission-reduction. To do so, the multiple candidate new devices and the current existing energy-consumption device 3 should be the same type of devices. For example, they are all air-conditioners or air-compressors. Under this circumstance, the multiple new devices have same operating parameters as the current existing energy-consumption device 3. The intelligent building system 21 respectively compute the power-consumed amount and carbon-emitted amount of the energy-consumption device 3 and the multiple new devices in accordance with same operating condition and same operating parameters, and then compute the benefit of each new device for energy-saving and emission-reduction with respect to the energy-consumption device 3, and the intelligent building system 21 may sort the multiple new devices based on their benefit with respect to the energy-consumption device 3.

As discussed above, the present disclosure uses the energy-consumption factor analyzing module 211 to obtain the plurality of operating parameters (i.e., energy-consumption factors) relevant to power-consumed amount and carbon-emitted amount of the energy-consumption device 3 when the energy-consumption device 3 operates in the environment within a specific historical time-period, and uses the new-device-parameter importing module 212 to obtain multiple performance coefficients relevant to the plurality of operating parameters of the multiple new devices being evaluated. Therefore, the simulating module 213 may respectively perform a simulation to generate an energy-consumption simulated result for each of the new devices as if each of the new devices were operated in the environment within the specific historical time-period in accordance with the multiple performance coefficients and the plurality of energy-consumption factors of each of the new devices.

In the present disclosure, the energy-consumption simulated result may disclose the possible power-consumed amount and carbon-emitted amount generated by the new device if the new device was arranged and used in the environment within the specific historical time-period. Therefore, the server 2 may executes a replacement-benefit estimating procedure based on the energy-consumption and carbon-emission result of the energy-consumption device 3 operated in the environment within the specific historical time-period and the energy-consumption simulated result of each new device generated by simulating the operation in the environment within the specific historical time-period. According to the estimating result of the replacement-benefit estimating procedure, the user may determine which improving approaches to be adopted or which new device to be replaced to rapidly or effectively implement the object of energy-saving and emission-reduction.

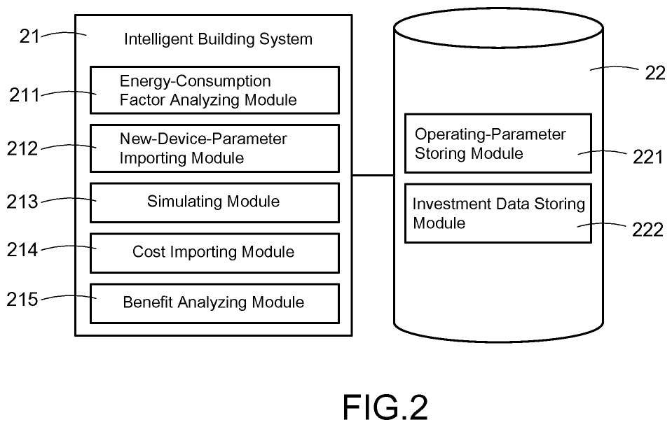

Please refer to FIG. 2, which is a schematic diagram of a server of an embodiment according to the present disclosure. As disclosed in FIG. 2, the database 22 of the present disclosure may further include an operating-parameter storing module 221 and an investment data storing module 222. In one embodiment, the operating-parameter storing module 221 and the investment data storing module 222 may be two storing components that are physically separated, such as two hard-drives or two memories. In another embodiment, the operating-parameter storing module 221 and the investment data storing module 222 may be two storing spaces that are logically separated.

The operating-parameter storing module 221 is used to store the corresponding values of each of the operating parameters of the energy-consumption device 3 according to a time series after the energy-consumption device 3 operates. These values are used for the energy-consumption factor analyzing module 211 to perform a correlation analysis in the following procedures. The investment data storing module 222 is used to store each cost imported by the user (such as the replacement costs of replacing the new devices), these data can be used by the intelligent building system 21 in the replacement-benefit estimating procedure.

In the embodiment of FIG. 2, the intelligent building system 21 may also include a cost importing module 214 and a benefit analyzing module 215.

The cost importing module 214 accepts user's operation through the human-machine interface of the intelligent building system 21 to receive and import multiple replacement costs of multiple new devices being estimated. In one embodiment, the multiple replacement costs include an average electricity cost, an average unit carbon-weight cost, and an investment cost. It should be mentioned that the multiple new devices may be same type of devices with different brands, different standards, or different models, so the new devices may have same average electricity cost and same average unit carbon-weight cost but different total investment costs. It is to say, the multiple new devices face the same fundamental rule of electricity fee and carbon-emission fee (based on the rule of the current country or geographic area), but may have different selling prices, transportation fees, installation fees, and maintenance fees.

In the present disclosure, the intelligent building system 21 executes the aforementioned replacement-benefit estimating procedure by the benefit analyzing module 215. In particular, the benefit analyzing module 215 may execute the replacement-benefit estimating procedure to the energy-consumption simulated result of each new device based on the replacement cost and outputs a best sorting result for energy-saving and a best sorting result for investment returns through the human-machine interface of the intelligent building system 21.

As mentioned above, the energy-consumption simulated result may show the simulated power-consumed amount and carbon-emitted amount of each new device in the environment. After comparing the energy-consumption simulated result with the energy-consumption and carbon-emission result, the energy-saving amount or emission-reduction amount of each new device may be estimated. By additionally combining with the replacement cost, the benefit analyzing module 215 may sort the multiple candidate new devices for energy-saving effect (i.e., the best sorting result for energy-saving) based on the energy-saving amount or the emission-reduction amount or sort the multiple candidate new devices for payback period length (i.e., the best sorting result for investment returns) based on the investment amount.

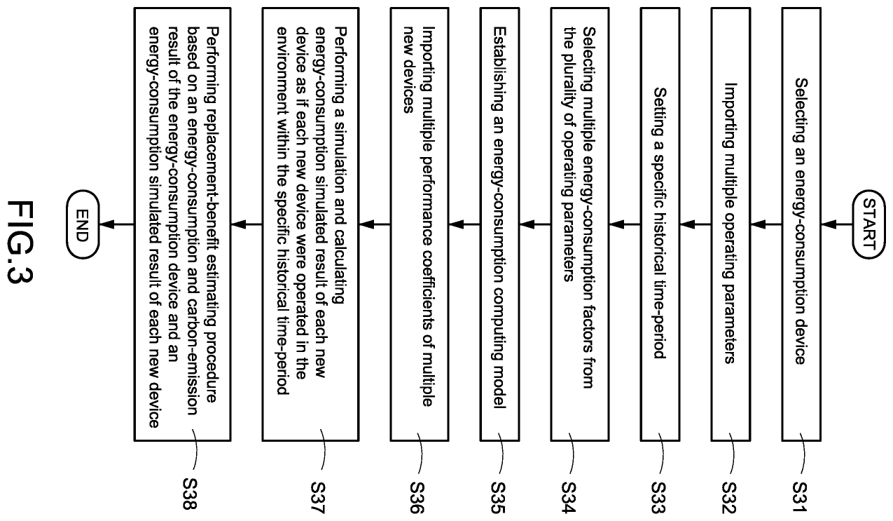

Please refer to FIG. 3, which is a flowchart of an estimating method of an embodiment according to the present disclosure. The present disclosure further discloses an estimating method for energy-saving and emission-reduction of energy-consumption device (referred to as the estimating method herein after), and the estimating method is adopted by the estimating system 1 as disclosed in FIG. 1 and FIG. 2.

First, when the user wants to use the estimating system 1 to perform an estimating procedure, the user selects one of the multiple current existing energy-consumption devices 3 of the estimating system 1 through the human-machine interface (step S31). After one of the energy-consumption devices 3 is selected, the estimating system 1 imports the multiple operating parameters of the selected energy-consumption device 3 (step S32).

As mentioned, the energy-consumption device 3 has the plurality of operating parameters as variables due to its functions, and the energy-consumption device 3 respectively records a corresponding data label for each of the operating parameters. In one embodiment, the estimating system 1 automatically imports the multiple operating parameters of the energy-consumption device 3 through the data label of the energy-consumption device 3 after the energy-consumption device 3 is selected. In another embodiment, after selecting the energy-consumption device 3, the user may manually input one or more operating parameters through the human-machine interface according to user's past experiences. In the embodiment, the operating parameter(s) input by the user may be the operating parameter(s) not directly relevant to the energy-consumption device 3 itself but relevant to the environment where the energy-consumption device 3 exists, such as human traffic or atmospheric temperature, etc. of the environment.

After the step S32, the intelligent building system 21 sets a specific historical time-period based on the user's operation (step S33), and selects a part of the operating parameters that are relevant to the power-consumed amount and carbon-emitted amount of the energy-consumption device 3 operating in the environment within the specific historical time-period from the plurality of operating parameters as the multiple energy-consumption factors (step S34). It should be mentioned that the amount of the part of operating parameters being selected is less than that of all operating parameters of the energy-consumption device 3.

In one embodiment, the intelligent building system 21 directly regards the part of operating parameters being selected as the multiple energy-consumption factors that are highly relevant to the power-consumed amount and carbon-emitted amount. In another embodiment, the intelligent building system 21 further performs a second selecting action to the part of operating parameters being selected to decide the multiple energy-consumption factors (detailed described in the following).

In one embodiment, the intelligent building system 21 executes algorithms of a correlation coefficient analysis, a variance inflation factor, or a collinearity diagnosis through the energy-consumption factor analyzing module 211 in the step S34, so as to compute a correlation index between each operating parameter of the energy-consumption device 3 and the power-consumed amount or carbon-emitted amount of the energy-consumption device 3 operating in the environment. By using the correlation index of each operating parameter, the energy-consumption factor analyzing module 211 may select the part of operating parameters that are highly relevant to the power-consumed amount or carbon-emitted amount from the plurality of operating parameters to be the multiple energy-consumption factors (detailed described in the following), wherein the amount of the multiple energy-consumption factors is less than or equal to the amount of the multiple operating parameters.

As mentioned above, the technical solution provided by the present disclosure is to combine the performance coefficients of the new device that the user wants to evaluate with the operating condition under which the energy-consumption device 3 has actually operated, so as to obtain a more precise energy-consumption/carbon-emission condition of the new device. In order to do so, the specific historical time-period has to be set to select the effective operating parameters.

As mentioned above, the database 22 of the present disclosure stores the corresponding values of the plurality of operating parameters of each energy-consumption device 3 based on a time series. After the specific historical time-period is set, the intelligent building system 21 may read the corresponding values of each operating parameter of the selected energy-consumption device 3 within the specific historical time-period from the database 22 so the energy-consumption and carbon-emission result of the energy-consumption device 3 within the specific historical time-period (i.e., the power-consumed amount and carbon-emitted amount) may be obtained.

By using the multiple selected energy-consumption factors, the corresponding values of each of the energy-consumption factors, and the energy-consumption and carbon-emission result, the intelligent building system 21 may establish an energy-consumption computing model for the energy-consumption device 3 (step S35).

Next, the intelligent building system 21 accepts the user's operation through the human-machine interface to import the multiple performance coefficients of the multiple new devices being estimated (step S36). Therefore, the intelligent building system 21 may respectively perform a simulation and calculate the energy-consumption simulated result of each new device as if each new device were operated in the environment within the specific historical time-period based on the multiple performance coefficients of each new device, the multiple energy-consumption factors being selected, and the corresponding values of each energy-consumption factor within the specific historical time-period (step S37).

In one embodiment, the performance coefficients are rational numbers. The intelligent building system 21 selects corresponding performance coefficients of the new device in accordance with the multiple selected energy-consumption factors (such as water temperature, flowing amount, and cooling ability), so as to update the energy-consumption computing model to be a model that is suitable for the new device. Next, the intelligent building system 21 imports the corresponding values of the multiple selected energy-consumption factors within the specific historical time-period (such as 5° C., 100CMH, and 30RT) into the updated energy-consumption computing model to obtain the power-consumed amount or carbon-emitted amount of the new device within the specific historical time-period (i.e., the energy-consumption simulated result).

It should be mentioned that different devices may have different performance coefficients, so the intelligent building system 21 may update the energy-consumption computing model to obtain different models for different new devices. When importing the corresponding values of each energy-consumption factor within the specific historical time-period into different energy-consumption computing models, the intelligent building system 21 may obtain different power-consumed amounts or carbon-emitted amounts of each new device. Therefore, the intelligent building system 21 may perform the replacement-benefit estimating procedure based on the energy-consumption and carbon-emission result of the current existing energy-consumption device 3 within the specific historical time-period and the energy-consumption simulated result of each new device within the specific historical time-period to obtain an estimated result for replacement benefit of these new devices (step S38).

In one embodiment, the estimated result indicates the energy-saving amount and emission-reduction amount that may be achieved after the current existing energy-consumption device 3 being replaced by each of the new devices. In another embodiment, the estimated result further indicates the energy-saving fee or the emission-reduction fee that may be saved after the current existing energy-consumption device 3 being replaced by each of the new devices. However, the above-mentioned estimated result is only one of the exemplary embodiments of the present disclosure, but not limited thereto.

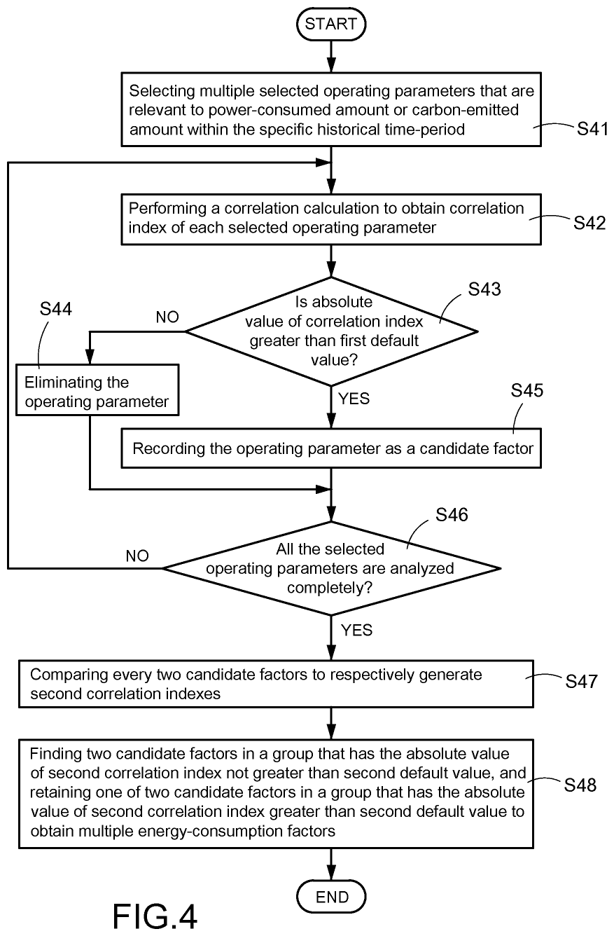

Please refer to FIG. 3 and FIG. 4 simultaneously, wherein FIG. 4 is a flowchart of selecting energy-consumption factor of an embodiment according to the present disclosure. FIG. 4 is used to detailed interpret how the intelligent building system 21 of the present disclosure selects the multiple energy-consumption factors being used for establishing the energy-consumption computing model from the plurality of operating parameters of the energy-consumption device 3.

In particular, the relationship between the power-consumed amount/carbon-emitted amount of the energy-consumption device 3 and the plurality of operating parameters may be presented as following:

Power-consumed amount (Power) or carbon-emitted amount (CO₂e)=f (operating parameter 1, operating parameter 2, operating parameter 3, operating parameter 4, . . . ).

In one embodiment, the intelligent building system 21 obtains the power-consumed amount of the energy-consumption device 3 in accordance with the above relationship and transforms the power-consumed amount of the energy-consumption device 3 into carbon-emitted amount of the energy-consumption device 3 based on a second relationship. In one embodiment, the intelligent building system 21 obtains the carbon-emitted amount of the energy-consumption device 3 based on the above relationship and transforms the carbon-emitted amount of the energy-consumption device 3 into the power-consumed amount of the power-consumption device 3 based on a third relationship.

When the energy-consumption device 3 operates within some certain time-periods, a part of operating parameters may be irrelevant to the power-consumed amount/carbon-emitted amount. In the present disclosure, the intelligent building system 21 needs to eliminate these irrelevant operating parameters in a first stage selecting procedure.

As disclosed in FIG. 4, after the user sets the specific historical time-period, the intelligent building system 21 performs a conditional query to the database 22 for the specific historical time-period to select the multiple selected operating parameters relevant to the power-consumed amount or carbon-emitted amount within the specific historical time-period from the plurality of operating parameters of the energy-consumption device 3 (step S41). Next, the intelligent building system 21 performs a correlation calculation to each of the selected operating parameters to obtain the correlation index of each of the selected operating parameters (step S42). By calculating the correlation index, the intelligent building system 21 may perform a second stage selecting procedure to each of the selected operating parameters.

In one embodiment, the intelligent building system 21 performs the correlation calculation through a correlation coefficient analysis, a variance inflation factor, or a collinearity diagnosis, but not limited thereto. The correlation coefficient analysis, the variance inflation factor, and the collinearity diagnosis are common technical solutions in the related technical field, detailed description is omitted here.

In the present disclosure, the correlation index is a rational number that its absolute value is greater than zero and smaller than or equal to one. The greater the absolute value of the correlation index, the more relevant the correlation index to the power-consumed amount/carbon-emitted amount will be.

After the step S42, the intelligent building system 21 determines whether the absolute value of the correlation index of the operating parameter currently analyzed is greater than a first default value (step S43). If the absolute value of the correlation index of the operating parameter is not greater than the first default value (such as 0.4), the intelligent building system 21 eliminates this operating parameter (step S44): if the absolute value of the correlation index of the operating parameter is greater than the first default value, the intelligent building system 21 retains this operating parameter and records this operating parameter as a candidate factor (step S45).

After the step S45, the intelligent building system 21 determines whether all the selected operating parameters are analyzed completely (step S46), and the intelligent building system 21 continuously executes the step S42 through the step S45 before all the selected operating parameters are analyzed completely, so as to determine whether to eliminate or retain each of the selected operating parameters through the calculation of the correlation index.

In one embodiment, the correlation index of each of the operating parameters may be exampled as the following table:

| | Power-Consumed Amount/ |
|---|---|
| | Carbon-Emitted Amount |
| Power-Consumed | 1 |
| Amount/Carbon-Emitted | |
| Amount | |
| Operating Parameter 1 | −0.592413002 |
| Operating Parameter 2 | −0.276284147 |
| Operating Parameter 3 | −0.39215308 |
| Operating Parameter 4 | −0.424438169 |
| . . . | . . . |
| Operating Parameter n | 0.524864973 |

In the embodiment of the above table, the absolute values of the correlation index of the operating parameter 1, the operating parameter 4, and the operating parameter n are greater than the first default value (0.4 for an example), so that the intelligent building system 21 records the operating parameter 1, the operating parameter 4, and the operating parameter 4 as the candidate factors.

In one embodiment, the intelligent building system 21 may perform the aforementioned second stage selecting procedure to the plurality of operating parameters in accordance with the correlation index and the first default value and then regards the multiple candidate factors selected from the second stage selecting procedure as the energy-consumption factors for establishing the energy-consumption computing model.

In another embodiment, the intelligent building system 21 further performs a third stage selecting procedure to the multiple candidate factors obtained from the second stage selecting procedure, so as to ensure that the lastly used energy-consumption factors are highly relevant to the power-consumed amount/carbon-emitted amount of the energy-consumption device 3 operating in the environment within the specific historical time-period.

In particular, after the second stage selecting procedure, the intelligent building system 21 may obtain multiple candidate factors. In the meantime, the intelligent building system 21 pairs each two of the multiple candidate factors as a group and compares every two candidate factors of every group to respectively generate a second correlation index for each group (step S47). In the present disclosure, the second correlation index represents the repeatability of the two candidate factors being compared. The greater the absolute value of the second correlation index, the higher the repeatability of the two candidate factors being compared is.

Because some operating parameters of the energy-consumption device 3 may have repeatability (such as two different types of water temperature including the water temperature at the inlet and the water temperature at the outlet), the present disclosure pairs each two of the multiple candidate factors as a group to perform the comparison. If two candidate factors in one of the multiple groups are found having low repeatability, the intelligent building system 21 retains both of the two candidate factors in this group as the energy-consumption factors: if two candidate factors in one of the multiple groups are found having high repeatability, the intelligent building system 21 only retains one of the two candidate factors in this group as the energy-consumption factor.

It should be mentioned that, if only one of the two candidate factors in the group is retained, the intelligent building system 21 may consider the correlation index of the two candidate factors obtained from the second stage selecting procedure, and the intelligent building system 21 may retain one of the two candidate factor that is higher relevant to energy-consumption (i.e., has higher absolute value of correlation index) than the other, to be the energy-consumption factor.

In the embodiment, the intelligent building system 21 compares the absolute value of the second correlation index of the two candidate factors being compared with a second default value (such as 0.6), finds the two candidate factors from one or more of the groups that have the absolute value of the second correlation index not greater than the second default value, and retains one of the two candidate factors from one or more of the groups that have the absolute value of the second correlation index greater than the second default value, to obtain the multiple energy-consumption factors (step S48).

The second correlation index may be represented as the following table:

| | | | | | Operating |
|---|---|---|---|---|---|
| | Operating | Operating | Operating | Operating | Parameter |
| | Parameter 1 | Parameter 5 | Parameter 8 | Parameter 9 | 16 |
| Operating | 1 | | | | |
| Parameter | | | | | |
| 1 | | | | | |
| Operating | −0.433581154 | 1 | | | |
| Parameter | | | | | |
| 5 | | | | | |
| Operating | 0.413021492 | 0.286898806 | 1 | | |
| Parameter | | | | | |
| 8 | | | | | |
| Operating | −0.22926352 | −0.232506729 | −0.649273065 | 1 | |
| Parameter | | | | | |
| 9 | | | | | |
| Operating | −0.252388217 | 0.715404181 | 0.258374563 | 0.012831605 | 1 |
| Parameter | | | | | |
| 16 | | | | | |

In the embodiment of the above table, the intelligent building system 21 retains the operating parameter 1, the operating parameter 5, the operating parameter 8, the operating parameter 9, and the operating parameter 16 to be the multiple candidate factors, and the intelligent building system 21 pairs each two of the multiple candidate factors as groups to compare every two candidate factors of each group and respectively compute the second correlation index of the candidate factors for each group. As disclosed in the above table, all the absolute value of the second correlation index generated by comparing the operating parameter 1 with other candidate factors are not greater than the second default value (such as 0.6), so that the intelligent building system 21 directly records the operating parameter 1 as one of the energy-consumption factors.

The absolute value of the second correlation index generated by comparing the operating parameter 5 with the operating parameter 16 is greater than the second default value (such as 0.6), so that the intelligent building system 21 only records the operating parameter 16 as one of the energy-consumption factors while eliminating the operating parameter 5. However, the intelligent system 21 may record the operating parameter 5 as one of the energy-consumption factors and eliminate the operating parameter 16 instead.

The absolute value of the second correlation index generated by comparing the operating parameter 8 with the operating parameter 9 is greater than the second default value (such as 0.6), so that the intelligent building system 21 only records the operating parameter 9 as one of the energy-consumption factors while eliminating the operating parameter 8. For another embodiment, the intelligent system 21 may record the operating parameter 8 as one of the energy-consumption factors and eliminate the operating parameter 9 instead.

However, the above descriptions are only few embodiments of the present disclosure, but not limited thereto.

After the step S48, the intelligent building system 21 obtains multiple energy-consumption factors that are most relevant to the power-consumed amount/carbon-emitted amount of the energy-consumption device 3 when the energy-consumption device 3 operated in the environment within the specific historical time-period. Therefore, the intelligent building system 21 may establish an energy-consumption computing model based on the corresponding values of the plurality of energy-consumption factors and the power-consumed amount of the energy-consumption device 3 within the specific historical time-period. For example, if the operating parameter 1, the operating parameter 9, and the operating parameter 16 are retained to be the multiple energy-consumption factors, the energy-consumption computing model may be presented as the following formula:

$$P = a 0 + a 1 \times X + a 2 \times Y + a 3 \times Z + a 4 \times X Y + a 5 \times X Z + a 6 \times Y Z + a 7 \times {X}^{2} + a 8 \times {Y}^{2} + a 9 \times {Z}^{2}$$

In the above energy-consumption computing model, P represents an instant power-consumption amount (KW) of the energy-consumption device 3 within the specific historical time-period, which is known information: X represents the corresponding value of the operating parameter 1 (which is one of the energy-consumption factors) within the specific historical time-period (such as 5° C. of water temperature), which is known information: Y represents the corresponding value of the operating parameter 9 (which is one of the energy-consumption factors) within the specific historical time-period (such as 100CMH of flowing amount), which is known information: Z represents the corresponding value of the operating parameter 16 (which is one of the energy-consumption factors) within the specific historical time-period (such as 30RT of colling ability), which is known information: a0˜a9 represent the performance coefficients of the energy-consumption device 3 with respect to each of the energy-consumption factors, which may be obtained from computation.

As mentioned above, the user may analyze the current existing energy-consumption device 3 by using the energy-consumption factor analyzing module 211 of the intelligent building system 21, so as to determine which energy-consumption factor(s) affects the power-consumed amount/carbon-emitted amount of this type of devices the most. As a result, when selecting a new device, the user may perform selection based on these energy-consumption factor(s).

More specific, when purchasing the new device, the user may require each manufacturer to provide the actual data on how these energy-consumption factors change in response to each new device. Or, the user may provide the above energy-consumption computing model to each manufacturer, so that each manufacturer may input the actual operating condition of each new device into the energy-consumption computing model to obtain the performance coefficients of each new device corresponding to each of the energy-consumption factors.

In the present disclosure, the intelligent building system 21 may import the performance coefficients of the new device into the energy-consumption computing model and also import the corresponding values of each of the energy-consumption factors within the specific historical time-period into the energy-consumption computing model to perform the simulation and calculate the power-consumed amount or carbon-emitted amount of the new device as if the new device were operated in the environment within the specific historical time-period under the same operating condition. Therefore, the intelligent building system 21 may compare the power-consumption/carbon-emission situation of the current existing energy-consumption device 3 with that of the new device being evaluated.

In particular, the intelligent building system 21 performs the simulation and calculates the power-consumed amount of the new device in accordance with the following formula:

$${P}_{b} = b 0 + b 1 \times X + b 2 \times Y + b 3 \times Z + b 4 \times X Y + b 5 \times XZ + b 6 \times Y Z + b 7 \times {X}^{2} + b 8 \times {Y}^{2} + b 9 \times {Z}^{2}$$

In the above formula, P_{b} represents an instant power-consumption amount (KW) of the new device within the specific historical time-period, which is unknown information; X, Y, and Z respectively represent the corresponding values of each of the energy-consumption factors within the specific historical time-period (such as 5° C. of water temperature, 100CMH of flowing amount, and 30RT of colling ability), which are known information: b0˜b9 represent the performance coefficients of the new device with respect to each of the energy-consumption factors. In the embodiment, b0˜b9 may be provided by the manufacturer of the new device, and X, Y, and Z may be obtained from the database 22. Therefore, the intelligent building system 21 may rapidly perform the simulation and calculate the power-consumed amount or carbon-emitted amount of the new device through using the formula.

By using the above formula, also, the intelligent building system 21 may perform the simulation and calculate a power-consumed amount (Pc) of a second new device (having performance coefficients c0˜c9), a power-consumed amount (Pd) of a third new device (having performance coefficients d0˜d9), and a power-consumed amount (Pe) of a fourth new device, etc., depending on user's real demand.

In one embodiment, the intelligent building system 21 may perform a linear regression analysis, a neural modeling procedure, or a multivariable regression analysis by the energy-consumption factor analyzing module 211, so as to establish the energy-consumption computing model in accordance with the multiple energy-consumption factors and the power-consumed amount of the energy-consumption device 3 within the specific historical time-period. Therefore, in the step S37 as shown in FIG. 3, the intelligent building system 21 may import the multiple performance coefficients of each new device and the corresponding values of the multiple energy-consumption factors within the specific historical time-period into the energy-consumption computing model, so as to respectively compute an energy-consumption simulated result of each new device as if each new device were operated in the environment within the specific historical time-period. After obtaining the energy-consumption simulated result of each new device, the intelligent building system 21 may compare the power-consumed amount/carbon-emitted amount of the current existing energy-consumption device 3 with that of the multiple new devices being evaluated on the same basis (i.e., under same operating condition).

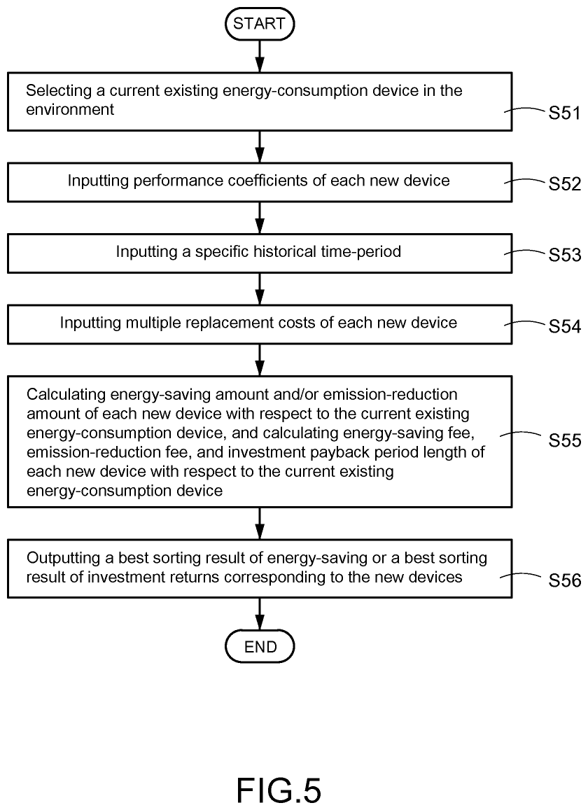

Please refer to FIG. 5, which is a flowchart of comparing investment returns of an embodiment according to the present disclosure. When the user wants to estimate the replacement benefit of replacing any type of the energy-consumption devices in the environment, the user may first select one of the multiple energy-consumption devices in the environment through the human-machine interface of the estimating system 1 (step S51). Then, the estimating system 1 selects the multiple energy-consumption factors and establishes the energy-consumption computing model based on the steps as shown and discussed according to FIG. 3 and FIG. 4. The user may ask each manufacturer about the performance coefficients of multiple new devices in accordance with the multiple energy-consumption factors and/or the energy-consumption computing model and then input the performance coefficients of each new device into the estimating system 1 through the human-machine interface (step S52).

To ensure that the current existing energy-consumption device 3 and the new device being evaluated have same comparing basis, the user may input a specific historical time-period through the human-machine interface (step S53). After the step S53, the estimating system 1 may inquire the database 22 based on the specific historical time-period to obtain the corresponding values of each of the energy-consumption factors within the specific historical time-period.

Next, the estimating system 1 receives multiple replacement costs of each new device input by the user through the human-machine interface (step S54). In one embodiment, the replacement costs may be, for example but not limited to, the average cost of electricity in the current country or geographic area (such as the cost per kilowatt-hour ($/kWh)), the electricity emission factor (such as the emission amount per kilowatt-hour (kg CO₂e/kWh)), the average unit carbon-weight cost ($/tCO2e), and the total investment cost of each new device ($).

After the step S54, the estimating system 1 may perform the simulation and calculate the power-consumed amount and/or carbon-emitted amount of each new device as if each new device were operated in the environment within the specific historical time-period. Therefore, the estimating system 1 may calculate the energy-saving amount and/or emission-reduction amount of each new device with respect to the current energy-consumption device 3 and also calculate the energy-saving fee, emission-reduction fee, and investment payback period length of each new device with respect to the current energy-consumption device 3 based on the replacement costs (step S55).

In one embodiment, the estimating system 1 shows at least one of the energy-saving amount (i.e., benefit of energy-saving), the emission-reduction amount (i.e., benefit of emission-reduction), the energy-saving fee (i.e., benefit of electricity fee), the emission-reduction fee (i.e., benefit of carbon weight), and the investment payback period length (i.e., benefit of total savings), so that the user may determine about how to select the required new device(s) and the required improving approach(es).

It should be mentioned that, in the present disclosure, the user may inquire an analyzing result that he or she wants through the human-machine interface. According to the selection made by the user, the estimating system 1 may output a best sorting result of energy-saving or a best sorting result of investment returns corresponding to the multiple new devices (step S56).

For example, the user may select an analyzing result that prioritizes energy-saving amount. In this embodiment, the estimating system 1 outputs the best sorting result of energy-saving for the multiple new devices, for example, the fourth new device>the first new device>the third new device>the second new device. In other words, the energy-saving/emission-reduction amount of the fourth new device is greater than that of the first new device, the energy-saving/emission-reduction amount of the first new device is greater than that of the third new device, and so on. Therefore, it is clear that if the user wants to reach a best energy-saving/emission-reduction result, the fourth new device should be purchased to replace the current energy-consumption device 3.

For another example, the user may select an analyzing result that prioritizes investment returns. In this embodiment, the estimating system 1 outputs the best sorting result of investment returns for the multiple new devices, for example, the second new device>the first new device>the fourth new device>the third new device. In other words, the investment payback period length of the second new device is shorter than that of the first new device, the investment payback period length of the first new device is shorter than that of the fourth new device, and so on. Therefore, it is clear that if the user wants to recover the investment cost in the shortest time-period (i.e., the accumulated energy-saving fee and the emission-reduction fee reach the cost of replacing the new device), the second new device should be purchased to replace the current energy-consumption device 3.

It should be mentioned that the new device having the highest investment returns may be not the new device having the best energy-saving/emission-reduction effect. If the user inputs the information of multiple new devices into the estimating system 1 for analysis, a plurality of improving approaches may be generated and provided by the estimating system 1 after analyzing.

The present disclosure predicts the probably power-consumed amount and carbon-emitted amount that may be generated by the new device as if the new device were actual operated in the environment based on past condition, so as to precisely estimate the benefit of energy-saving/emission-reduction and the benefit of investment returns.

As the skilled person will appreciate, various changes and modifications can be made to the described embodiment. It is intended to include all such variations, modifications and equivalents which fall within the scope of the present invention, as defined in the accompanying claims.

What is claimed is:

1. An estimating system for energy-saving and emission-reduction of energy-consumption device, comprising:
an energy-consumption device being arranged in an environment, configured to continuously operate in accordance with multiple operating parameters and generate an energy-consumption and carbon-emission result;
an IO module connected with the energy-consumption device, configured to obtain corresponding values of each of the operating parameters while the energy-consumption device operates;
a server connected with the IO module through a network communication device, configured to receive each of the operating parameters of the energy-consumption device and the corresponding values of each of the operating parameters, and comprising:
an operating-parameter storing module, configured to store the corresponding values of each of the operating parameters based on a time series;
an energy-consumption factor analyzing module, configured to select a part of the operating parameters that are relevant to the energy-consumption and carbon-emission result within a specific historical time-period from the multiple operating parameters based on the corresponding values to be multiple energy-consumption factors;
a new-device-parameter importing module, configured to import multiple performance coefficients of multiple new devices, wherein the multiple new devices and the energy-consumption device are devices with same type; and
a simulating module, configured to respectively perform a simulation and calculate an energy-consumption simulated result of each of the new devices as if each of the new devices were operated in the environment within the specific historical time-period based on the multiple performance coefficients of each of the new devices and the multiple energy-consumption factors;
wherein, the server is configured to perform a replacement-benefit estimating procedure based on the energy-consumption and carbon-emission result of the energy-consumption device within the specific historical time-period and each energy-consumption simulated result of each new device.

2. The estimating system in claim 1, wherein the server further comprises:
a cost importing module, configured to receive multiple replacement costs of the new devices;
an investment data storing module, configured to store the multiple replacement costs; and
a benefit analyzing module, configured to perform the replacement-benefit estimating procedure to each of the energy-consumption simulated results based on the multiple replacement costs, wherein the replacement-benefit estimating procedure is performed to output a best sorting result of energy-saving or a best sorting result of investment returns for the multiple new devices.

3. The estimating system in claim 2, wherein the multiple replacement costs comprise an average electricity cost, an average unit carbon-weight cost, and a total investment cost, wherein the multiple new devices have same average electricity cost and same average unit carbon-weight cost but have different total investment costs.

4. The estimating system in claim 1, wherein the energy-consumption factor analyzing module is configured to compute a correlation index between the multiple operating parameters of the energy-consumption device and a power-consumed amount or carbon-emitted amount of the energy-consumption device operating in the environment in accordance with a correlation coefficient analysis, a variance inflation factor, or a collinearity diagnosis, and select the multiple energy-consumption factors from the multiple operating parameters based on the correlation index.

5. The estimating system in claim 1, wherein the energy-consumption factor analyzing module is configured to decide the multiple energy-consumption factors through executing the following procedures:
selecting the energy-consumption device to be estimated;
importing the multiple operating parameters of the energy-consumption device;
setting the specific historical time-period to select multiple selected operating parameters that are relevant to a power-consumed amount or carbon-emitted amount within the specific historical time-period from the multiple operating parameters;
performing a correlation calculation to the multiple selected operating parameters to obtain a correlation index of each of the selected operating parameters; and
retaining multiple selected operating parameters that have the correlation index greater than a first default value to be multiple candidate factors and regarding the multiple candidate factors as the multiple energy-consumption factors.

6. The estimating system in claim 5, wherein the procedure of importing the multiple operating parameters of the energy-consumption device comprises automatically importing the multiple operating parameters by the server in accordance with a data label of the energy-consumption device and receiving one or more of the operating parameters input manually by a user.

7. The estimating system in claim 5, wherein the energy-consumption factor analyzing module is configured to perform the correlation calculation based on a correlation coefficient analysis, a variance inflation factor, or a collinearity diagnosis.

8. The estimating system in claim 1, wherein the energy-consumption factor analyzing module is configured to decide the multiple energy-consumption factors by executing the following procedure:
selecting the energy-consumption device to be estimated;
importing the multiple operating parameters of the energy-consumption device;
setting the specific historical time-period to select multiple selected operating parameters that are relevant to a power-consumed amount or carbon-emitted amount within the specific historical time-period from the multiple operating parameters;
performing a correlation calculation to the multiple selected operating parameters to obtain a correlation index of each of the selected operating parameters;
retaining multiple selected operating parameters that have the correlation index greater than a first default value to be multiple candidate factors;
pairing each two of the multiple candidate factors as groups to compare every two candidate factors in each of the groups to respectively generate a second correlation index for each group; and
finding multiple candidate factors in one or more groups having the second correlation index not greater than a second default value and retaining one of the two candidate factors in one or more groups having the second correlation index greater than the second default value to be the multiple energy-consumption factors.

9. The estimating system in claim 8, wherein the energy-consumption factor analyzing module is further configured to execute the following procedures:
establishing an energy-consumption computing model based on corresponding values of the multiple energy-consumption factors within the specific historical time-period and the power-consumed amount of the energy-consumption device within the specific historical time-period by using a linear regression analysis, a neural modeling procedure, or a multivariable regression analysis.

10. The estimating system in claim 9, wherein the simulating module is configured to import the multiple performance coefficients of each of the new devices into the energy-consumption computing model to respectively compute the energy-consumption simulated result of each of the new devices as if each of the new devices were operated in the environment within the specific historical time-period.

11. An estimating method for energy-saving and emission-reduction of energy-consumption device, incorporated with an estimating system at least comprising an energy-consumption device, a server, and a database, the energy-consumption device continuously operating in an environment based on multiple operating parameters to generate an energy-consumption and carbon-emission result, the server receiving the multiple operating parameters of the energy-consumption device and corresponding values of each of the operating parameters, the database storing the corresponding values of the operating parameters according to a time series, and the estimating method comprising:
a) selecting the energy-consumption device;
b) importing the multiple operating parameters of the energy-consumption device;
c) selecting a part of the operating parameters that are relevant to the energy-consumption and carbon-emission result within a specific historical time-period from the multiple operating parameters to be multiple energy-consumption factors;
d) obtaining multiple performance coefficients of multiple new devices, wherein the multiple new devices and the energy-consumption device are devices of same type;
e) respectively performing a simulation and calculating an energy-consumption simulated result of each of the new devices as if each of the new devices were operated in the environment within the specific historical time-period in accordance with the multiple performance coefficients of each of the new devices and the multiple energy-consumption factors; and
f) performing a replacement-benefit estimating procedure for each of the new devices based on the energy-consumption and carbon-emission result of the energy-consumption device within the specific historical time-period and each energy-consumption simulated result of each of the new devices.

12. The estimating method in claim 11, wherein the step b) comprises automatically importing the multiple operating parameters based on a data label of the energy-consumption device and receiving one or more of the operating parameters manually input by a user.

13. The estimating method in claim 11, wherein the replacement-benefit estimating procedure comprises:
f1) receiving multiple replacement costs of each of the new devices;
f2) computing an energy-saving amount and an emission-reduction amount of each of the new devices with respect to the energy-consumption device, and computing an energy-saving fee, an emission-reduction fee, and an investment payback period length of each of the new devices with respect to the energy-consumption device based on the multiple replacement costs; and
f3) outputting a best sorting result of energy-saving or a best sorting result of investment returns for the multiple new devices.

14. The estimating method in claim 13, wherein the multiple replacement costs comprise an average electricity cost, an average unit carbon-weight cost, and a total investment cost, wherein the multiple new devices have same average electricity cost and same average unit carbon-weight cost but have different total investment costs.

15. The estimating method in claim 11, wherein the step c) comprises:
c1) selecting multiple selected operating parameters that are relevant to a power-consumed amount or carbon-emitted amount within the specific historical time-period from the multiple operating parameters;
c2) performing a correlation calculation to the multiple selected operating parameters to obtain a correlation index of each of the selected operating parameters;
c3) determine whether the correlation index is greater than a first default value;
c4) eliminating one or more of the selected operating parameters having the correlation index not greater than the first default value; and
c5) retaining multiple selected operating parameters having the correlation index greater than the first default value to be multiple candidate factors, and regarding the multiple candidate factors as the multiple energy-consumption factors.

16. The estimating method in claim 15, wherein the step c2) performs the correlation calculation through a correlation coefficient analysis, a variance inflation factor, or a collinearity diagnosis.

17. The estimating method in claim 15, wherein the step c5) comprises:
c51) pairing each two of the multiple candidate factors as groups to compare every two candidate factors in each of the groups to respectively generate a second correlation index for each group;
c52) finding multiple candidate factors in one or more groups having the second correlation index not greater than a second default value and regarding the multiple candidate factors as a part of the multiple energy-consumption factors; and
c53) retaining one of the two candidate factors in one or more groups having the second correlation index greater than the second default value to be the part of the multiple energy-consumption factors.

18. The estimating method in claim 17, further comprising a step g): establishing an energy-consumption computing model based on corresponding values of the multiple energy-consumption factors within the specific historical time-period and the power-consumed amount of the energy-consumption device within the specific historical time-period:
wherein the step e) comprises importing the multiple performance coefficients of each of the new devices into the energy-consumption computing model to respectively calculate the energy-consumption simulated result of each of the new devices as if each of the new devices were operated in the environment within the specific historical time-period.

19. The estimating method in claim 18, wherein the step g) establishes the energy-consumption computing model by using a linear regression analysis, a neural modeling procedure, or a multivariable regression analysis.
